(19) United States
(12) Patent Application Publication
(10) Pub. No.: US 2012/0221466 A1
(43) Pub. Date: Aug. 30, 2012

(54) METHOD FOR IMPROVED FINANCIAL TRANSACTIONS

(76) Inventor: Thomas Finley Look, Ramsey, MN (US)

(21) Appl. No.: 13/407,400

(22) Filed: Feb. 28, 2012

Related U.S. Application Data
(60) Provisional application No. 61/464,017, filed on Feb. 28, 2011.

(51) Int. Cl. G06Q 20/22

(52) U.S. Cl. 705/39

(57) ABSTRACT

Disclosed are methods and processing techniques for modifying or changing a financial transaction that is being processed, such as for the purchase of goods or services. Methods of the present invention, in particular, relate to methods including the ability to use fixed or variable data, as such data is sent to a financial transaction processor, in order to modify the transaction, and thus changing the financial transaction that is being processed or the method of processing the financial transaction. The modifications that are made to the transaction enhance security to the buyer by disclosing less data during the transaction for others to potentially gain access.

### CROSS-REFERENCE TO RELATED APPLICATIONS

This application claims the benefit of U.S. Provisional application No. 61/464,017 filed Feb. 28, 2011 entitled “METHODS FOR IMPROVED FINANCIAL TRANSACTIONS”, the entire disclosure of which is incorporated herein.

### TECHNICAL FIELD

The present invention relates to the field of financial transactional methods or processing and manners of changing such a financial transaction that is being processed. Methods of the present invention, in particular, relate to methods including the ability to use fixed or variable data, as such data is sent to a financial transaction processor, in order to modify the transaction, and thus changing the financial transaction that is being processed or the method of processing the financial transaction.

### BACKGROUND OF THE PRESENT INVENTION

Problems that are associated with using financial cards to conduct financial transactions are numerous and well known. Financial cards are connected with financial accounts, which cards typically include the owner's name, account number, expiration date and 3 digit CVV code on its front and/or back card faces. With this data and even less, it is possible for non-card owners who have pirated the information or who have stolen such a card to buy store front goods, order goods using the internet or phone, pay bills, convert goods to cash all using someone else's money and good name. The cost and time to fix financial accounts and repair one's reputation can be extreme. Problems are also caused by the theft of data by raiding corporate databases, by simply recording the data while handling a buyer's financial card, by pilfering the data during a phone or internet use of the financial card, or by simply conning a card holder out of the data during a spoofed call or internet message from the alleged financial card company. Banks that issue the cards continue to use antiquated methods of conducting the transactions where losses are not discovered for 24 hours or more based on batched translations at night allowing a criminal plenty of time to act. The banks most often suffer the monetary loss, but the individual card holder may also need to restore their reputation and bank accounts, perhaps taking months of time. The banks profit in transaction fees so that their losses are covered while an individual card holder suffers.

While ways have been developed to attempt to stop this problem, both banks and merchants that accept financial transaction cards have issues with changing the system. There is reluctance within this business of conducting financial transaction to spend the time and/or money to implement an improved financial transaction system that will not otherwise benefit a business's bottom line or improve the efficiency of the transaction process. Use of PIN (personal identification number) numbers that are known only by the card holder for every transaction, fingerprint identification of the card holder, and similar concepts could solve a vast majority of the problems. However, such solutions cost a great deal to implement and add time to every transaction. For example, it is common for a merchant to simply tell a buyer when using an automated system to press a button for a credit transaction when using a debit card rather than as a debit card, even though their transaction costs are higher in order to speed up the transaction. There is no unified cry by the public to change the system because most have not lost money nor had the pain of clearing their name.

What is needed is a financial transaction system that costs banks and merchants little or nothing to implement, that works as quickly and smoothly as the current system, that does not add to or change the already in place infrastructure of financial card processing equipment, and that eliminates the ability of the criminals to obtain the card data to rob accounts. Additionally, a reduction in financial loses and potential savings in producing less financial cards would be a desirable benefit. It has been reported by Gartner, Inc. that approximately 7.5 percent of U.S. adults have lost money as a result of some sort of financial fraud in 2008 in large part because of data breaches.

Buyers presently enjoy tremendous capability to purchase goods and services, i.e., conduct financial transactions, almost anywhere in the world. The US Banking system, in particular, facilitates this activity, through conventional means such as wire-transfers, checks and funds-transfers through the automated clearing house network (ACH—operated by The Electronic Payments Association, NACHA), and through regional networks such as Star and Mac, or national and international networks such as MasterCard, Visa, Amex, and the like. Often, traditional bank accounts are connected to these various networks by an issuing bank, and the buyer is given a card (debit or credit), which they present at a point of sale, or they simply enter the account number on the card into a web page for an online purchase. The purchase, then, initiates a transfer of funds from the card/account holder's bank account to the merchant's account in exchange for goods and services. The issuing bank typically is the bank that holds the buyer's account, and also is a member of the network(s) indicated on the particular card. From the network provider's perspective (e.g., Visa), the bank that caused the card to be issued is the “issuing bank.”

Identifying those networks that are connected to a given account can often be accomplished by looking at the reverse side of a card, where the logos of the various networks, often called “bugs,” are printed. These various networks, when they are not specific to a particular merchant or venue, are called “open-loop” in the payments industry. Visa, MasterCard, Amex, Discover, and Star are examples of networks that, when associated with a card and account, make the card “open-loop.” It is noted that it is not necessarily a “card” that is open or closed-loop, but it is rather the nature of the account “behind” the card. As such, open loop account numbers can be just as easily associated with, e.g., cell phones, a key, or a voucher.

Merchants today often try to increase their market share and drive business by offering programs such as loyalty programs, merchandise discounts, extended payments, increased services and the like. In order to offer these features in an easy to use, efficient manner, a merchant would benefit from tools that are not currently available. Such merchants have only a limited means of marketing the services offered to targeted audiences and implementing the services in a user-friendly cost effective manner. As one example, Veritec Inc., of Golden Valley, Minn., sells products and services that control methods of using a buyer's mobile phone as a means of marketing using coupons, ticketing, gift cards, loyalty programs, and the like, and, at the same time, that can also be a provider of financial account data for securely conducting financial transactions. The means, according to the Veritec system, of electronically transmitting the data is by using a 2D code that can be displayed on the phone screen. With this system, a merchant has a method of targeting a specific audience in real time and the ability to introduce services and programs to buyers via their mobile phone while at the same time allowing the transaction of business along with these unique offerings and by using the same mobile phone.

An issue for non-financial card transactions is implementing phone code financial accounts and phone code coupons such that minimum support in a merchant's POS (point of sale) computers or devices is required. Today if phone codes were implemented, there likely would be problems with both supplying hardware and software to POS devices at merchant POS sites. Without a reader that is enabled to read any specific 2D barcode, for example, that is displayed on the phone at the point of sale, there would be no capability of conducting a phone code transaction other than by manually entering data that is represented and encoded within the 2D barcode. Although some merchants may have 2D code readers at the point of sale, they might also be required to have other or additional firmware to read other specific 2D barcodes, for example, such as the VeriCode™ phone code also available from Veritec Inc., assuming a reader has a capability to read phone displayed codes that are under glass with high glare. To consistently read phone displayed codes, a device specifically made for this task should be utilized. Most all PUS devices are programmed to work using fixed firmware that is under the control of a financial card processor with minimal interest in migrating business to a competitive processor that is enabled to work with financial phone codes. If reading of phone codes requires changes to the firmware on POS devices, most likely the POS device would require replacement with a new POS device that is enabled with new firmware. The installed base of typical POS devices is so large that any such change would also be very expensive.

Under normal circumstances, a card based financial transaction includes at least three elements; the data that identifies the payee and associated financial institution, the data that identifies the payer and associated financial institution and the monetary amount of the transaction. Payer data is normally found on the first two tracks of a conventional financial card magnetic stripe (according to the accepted conventional standard), which payer data is normally transmitted into a financial transaction by swiping of the card in a reader. Payee data is normally preloaded into a POS device or held in memory in whatever processing method is being employed (POS Computer). A monetary amount is either hand entered into the POS device or generated by a POS computer. These three elements are typically uploaded through various means to processing centers that will authenticate a transaction, debit and credit the payee and payer accounts as well as dispersing transactional fees to those companies handling the transaction (Legacy Financial card Transaction). Any additional, varied, modifications to the transaction such as discounts, loyalty credits or debits, coupons, gift cards and the like are typically handled separately either by manual calculations or in the POS Computer. A payer must exercise a great deal of care at the point of sale to be sure that all available discounts or credits have been applied to the transaction. This process could be made more reliable and faster if the financial transaction processor could handle some portion of the modifications to a financial transaction.

Payer financial card magnetic stripe data conventionally contains a payer name, a payer account number, a card expiration date and discretionary data such as a PIN number, the CVV code and similar data. Most often, a magnetic stripe includes redundant data for values that are numbers. All data on conventional magnetic stripes falls into the ASCII range of characters. Track 1 of a conventional stripe uses (64) different characters and track 2 uses (16) different characters. Both track 1 and track 2 have null, unused characters in the discretionary data field that can be filled with data conveying instructions to a financial transaction processor.

### SUMMARY OF THE PRESENT INVENTION

Processes are described herein that solve one or more of the afore-mentioned problems, without adding significant or any costs or increased transaction burdens to banks or merchants, that will also benefit both banks and merchants, and that reduce the risk of identity theft for a card holder. The premise of the invention is to reduce the availability of buyer data to others in order to provide greater security during a financial transaction. This can be accomplished in a variety of ways by modify the transaction process, including aspects of the transfer of data between, a buyer, a merchant, and a transaction processing party and at a variety of different stages.

Terms used hereinafter within this disclosure:
1. Financial Card—A typically plastic card used by an individual to conduct Financial Transactions tied to a Financial Account held by the individual, that is issued by a Bank, and minimally contains textual data including the individual's name, the Financial Account number, the expiration date of the Financial Card, a 3 digit security code called the CVV and a magnetic stripe with the same data that can be electronically read.
2. Financial Account—The Financial Card, Financial Account instrument, or any Financial Account authorized by a Bank or Bank agents, whereby an individual contracts with a Bank to provide the service of authorizing and making monetary transactional payments to Merchants on behalf of the individual and to settle all costs associated with the transaction.
3. Financial Account Holder—The Financial Card, Financial Account Holder is the individual that has contracted with a Bank to purchase goods or services from and make monetary payments to a Merchant using a Financial Card, Financial Account means to conduct a Financial Transaction. The Financial Account Holder, within this disclosure, will be known as the Buyer.
4. PAN—The Legacy Financial Card, Primary Account Number 16 digit to 19 digit number is known as the PAN which includes numbers identifying the Bank holding the Financial Account (BIN) and the Financial Account number.
5. Financial Transaction—The process by where a Buyer purchases goods or services from a Merchant and uses the Financial Account in order to pay for goods or services.
6. Merchant—A Merchant is any provider of goods or services that will receive monetary compensation, from a Buyer's Financial Account, for the goods or services provided to a Buyer.
7. Bank—A Bank is the legal entity that issues a Financial Account and Financial Card to a Buyer and is responsible for settling the monetary value of the transaction with a Merchant and the costs of the transaction with the service providers that facilitate the transaction.
8. Processor—A service provider that often handles under contract, for the Bank, the processing of a Financial Transaction by receiving an electronic transferred request from the Merchant including the Merchants data, the Buyer's Financial Card account data and the monetary value of the transaction and then facilitates the debiting and crediting of the Buyer's and Merchant's Financial Accounts as well as those of the service providers handling the transaction. A Bank may provide this service themselves.
9. POS Systems—The hardware and software used by Merchants to conduct a Financial Transaction that utilizes a Financial Card or minimally the 16 digit Financial Card PAN number and expiration data to implement a Financial Transaction.
10. Processor or Bank/Processor—The term Processor or Bank/Processor implies a relationship between the Bank and Processor that has shared functions with the Bank having authority. The Processor can have a minor role increasing to the Bank only holding funds and the Processor controlling all aspects of a Financial Transaction. A Bank may provide all of the services of the Processor themselves.
11. Innovative New Financial Transaction—The innovative process and inventions described in this disclosure concerning Financial Accounts and Financial Transactions.
12. Bank/Processor Membership Number—The Bank/Processor will typically have a legal agreement between themselves and Buyer and the Merchant providing financial services as described herein. The contracts are identified by a Bank/Processor Membership Number which at a minimum will be a 16 digit number, functionally much like current Financial Card PAN numbers and perhaps a second shorter number to protect the 16 digit number from public disclosure. It should also be noted that the Legacy Financial Account number, provided to the Merchant by a Bank or Processor for the acceptance of Financial Cards through a POS system, can be used to replace the Bank/Processor Membership Number within the scope of this invention.
13. Mobile Phone—Any of a number of mobile electronic devices that can display data and graphics on a screen and has a wireless communication means.
14. 2D Code—A graphic matrix symbology that has data encoded in the matrix pattern.
15. Account Data String—The data, commonly found on a Financial Card's magnetic stripe that identifies the Financial Account, the issuing financial institution and Financial Transaction Processor, the account holder, expiration data and security means to authenticate both the Financial Account and card holder.
16. Modified Account Data String—Any Account Data sent to a Processor that has data in the string such that the that data can effect changes to a Financial Transaction being processed or the method of processing the transaction not incorporated in a Legacy Financial Transaction.

Today a Buyer will acquire goods and services from a Merchant and use their Legacy Financial Card to pay for those goods and services. Legacy as used throughout this application as a modifier means the conventionally accepted system or systems as are used today in standardized transaction systems for financial transactions. A Buyer may present the Financial Card to the Merchant directly in a face-to-face transaction using the Merchants POS system or provide the card data remotely for a phone or internet purchase. In either case, a Merchant or others who may be illegally recording card data mayl have access to the four critical Financial Card data components; Buyer's name, Buyer's account number, expiration date and 3 digit CVV code. It is possible for a Merchant employees, for example, to obtain this data from a transaction receipt and memorizing the other details or for a phone or online operator to simply walk off with the data or a criminal that intercepts data being transferred electronically from a computer. The innovative Financial Transaction process of the present invention will prevent the disclosure of Buyer's personal and Financial Account data to the Merchant. It will also prevent personal or Financial Account data from being transmitted electronically or verbally over the internet of phone.

A process of the present invention starts with a Bank/Processor contracting with the Merchant and/or Buyer to provide this innovative new service. For example, once the new Financial Transaction system is in place, the Merchant can send a Bank/Processor a request, using a standard POS system and a Financial Card with an account number that triggers the new process. The data sent can include the Merchant's data and the monetary values of the transaction. The Processor can then send back to the Merchant a receipt, using the same method as the Legacy POS system, which has the Merchant data, the monetary data and a code with 2 to 5 digit number that represents the Financial Transaction. The Merchant can then present the receipt or just the code to the Buyer. The Buyer may run an application, such as has been provided by the Bank/Processor, on their Mobile Phone that wirelessly connects the Buyer's phone to the Processor. The application will preferably then ask the Buyer to choose which Financial Account for the transaction (if more than one is available), if the Buyer would like to provide a tip for a service and to enter the 2 to 5 digit number. The Processor can then immediately return to the Buyer's phone the details of the Financial Transaction represented by the 2 to 5 digit number including the goods or services cost, tips if included and taxes, the Financial Account chosen, and the Merchant information. If the Buyer accepts the sent data they can then also acknowledge the transaction by pressing a key on the phone or entering a PIN which may also enact an electronic signature for the transaction. The Processor can then send an acknowledging receipt to the Merchant's Legacy POS system for their records and the same receipt to the Buyer's phone.

A similar method in accordance with aspects of the present invention would have a Buyer furnishing a Merchant a membership number in the Bank/Processor system that the Merchant would send to a Processor along with Merchant data and the total costs for goods, services and taxes. This method would allow a Processor to directly contact a Buyer's phone and proceed, such as described just above, with a Financial Transaction without the use of the 2 to 5 digit Financial Transaction number but using a Buyer's Bank/Processor membership number to identify the Buyer's Financial Account.

A third similar method also in accordance with aspects of the present invention would have a Merchant providing a Buyer with a Bank/Processor membership number that is specific to them, the total costs for goods, services and taxes, and a 2 digit (for example) transaction number. The Buyer could then run a Bank/Processor application on their Mobile Phone, and upon being prompted could enter the Merchant Bank/Processor membership number, the total costs for goods, services and taxes, a Financial Account to use for the transaction, and the 2 digit transaction number and a tip if desired. The phone would preferably forward this data to a Processor along with the Buyer's Bank/Processor membership number. The Processor would preferably then immediately return to the Buyer's phone certain details of the Financial Transaction represented by the 2 digit number furnished by the Merchant including the goods or services cost, tips if included and taxes, a Financial Account chosen, and Merchant information. If the Buyer accepts the sent data they can then acknowledge the transaction by pressing a key on the phone, for example, or entering a PIN, as another example, which can then enact an electronic signature for the transaction. The Processor can also send an acknowledging receipt to the Merchant's Legacy POS system, including the 2 digit transaction number, for their records and the same receipt to the Buyer's phone. Note that any data transferred by the Buyer's Mobile Phone could preferably be encrypted for security.

A Financial Transaction method in accordance with the present invention also has other benefits for a Merchant and Buyer. While there is no Financial or personal data required to be transferred as part of a Financial Transaction in accordance with methods of the present invention, a Merchant can also offer a Buyer incentives to participate in Merchant marketing programs. These programs could include loyalty points to be exchanged for discounts on future purchases based on Buyer's use of the Merchants offerings. For example, a Mobile Phone coupon campaign can be implemented where the discounted goods or services are offered by the Merchant are sent to a Buyer's Mobile Phone. In each case the Buyer can remain anonymous to the Merchant, where a Processor can handle the tracking of a Buyer's purchases, loyalty discounts or discounting of coupon merchandise or services.

Having a Bank/Processor application running on a Buyer's phone offers many additional opportunities for a Bank, Merchant, Buyer and Processor. As part of a Bank/Processor agreement with a Buyer, a Bank could offer or require additional service offerings to the Buyer. A Buyer's Mobile Phone could be a new account manager for the Buyer's Bank accounts providing instant access to all or less of Banking services and transactions and cutting down on paper documents sent to the Buyer. This instant notification method could help sell Banking services as well as stopping overdrafts of Financial Accounts because real time data is not currently available with prior art methods and systems. A Merchant would not be subjected to charge backs based on Legacy fraud in accepting Financial Cards. Electronic Gift Cards for a Buyer could be managed through a Processor for discounting purchases from a Merchant. A Merchant, through a Processor could also design marketing campaigns based on demographic data that the Processor would filter for the Merchant. A Buyer would be protected from identity theft, could be notified of every transaction on all accounts at the Bank, take advantage of loyalty points and discounts without any overt action, conduct diverse Financial Transactions such as account to account transfers, toggling an account on and off, checking balances, paying bills and the like, anytime and anywhere. A Processor would be able to offer additional services which, as implemented in software, can also be highly profitable.

The advantages for the innovative Financial Process are numerous. For example, to a Bank, advantages can include the following. Processes in accordance with aspects of the present invention may no longer require a name brand Financial Card such as Visa, Master Card, Discover, America Express and the like to assure to Merchants that they will be paid. Fees that are normally paid for using name brand cards can now be spread among other participating parties or used to reduce Merchant fees. There would no longer be a requirement for a plastic Financial Card to be issued, which is often a Bank expense. If 7.5% of Buyers are experiencing fraud and Banks most often take responsibility for the monetary loss of fraud, the lack of criminals ability to steal Buyer's identity will reduce Bank loss. A Bank can sell also provide or sell additional services and provide superior service to a Buyer using a Bank/Processor application running on a Buyer's Mobile Phone.

Advantages to a Merchant can include the following, for example. A Merchant would not be required to change their Legacy hardware driven POS system. For those Merchants using a software driven POS method the only difference may be software changes to their current POS application that reflect how credit receipts are reported through there accounting system. A Merchant can offer loyalty and coupon marketing that are directed specifically at the Buyer's purchasing habits. Monetary loss from bad Financial Card Transactions and lost reputation from employees stealing Buyer identities could be a thing of the past.

For service Merchants a multiple action Legacy Financial Card Transaction, such as for restaurant services, is normally done based upon the follow steps. First, the service Merchant presents a Buyer with their bill for services. Then, the Merchant picks up the Buyer's Financial Card, runs the Buyer's Financial Card through the POS system, takes a receipt and card back to the Buyer, potentially gets the Buyer to add a tip and sign the receipt, takes the receipt back to the POS system, finds the transaction and rerun the transaction with the tip. This process could be changed by processes of the present invention by simply furnishing the Buyer a 2 to 5 digit, for example, transactional code or getting the Buyer's Bank/Processor membership number or providing a Buyer with a Merchant Bank/Processor membership number, along with the total costs for goods, services and taxes, and a 2 digit transaction number. This could all be done within a single action. It is contemplated that a Merchant might also be able to procure a reduction in Financial Transaction processing fees based upon the use of processes and systems in accordance with the present invention.

Advantages to a Buyer are also potentially numerous including the following. A Buyer is potentially the best served member of the Bank/Processor group in that they can gain a great deal of control over their financial lives while saving time, money and frustration. Advantages include the prevention of identity theft, as a Buyer's personal data would not be exposed to unknown persons, such as during a transaction. Loyalty points and discounted deals can be provided to Buyers without having to remember to do anything or exposing personal data to a Merchant. Buyers would have real time account and transaction data available to them and could conduct banking transactions anywhere and at anytime. Secure transactions could be conducted whether at a brick and mortar retail location, by phone, or in conducting internet transactions. There could also be an elimination of paper transaction receipts since both a Buyer's Mobile Phone and a Processor would have such data for future use that could also be downloaded to a application running on a Buyer's computer. There is additionally a potential for reduced Financial Transaction service fees based on lower fraud losses, lower Bank cost for maintaining the Buyer's Financial Account and the higher value of a Buyer to a Merchant.

For a Processor, specific advantages can also include the following. A Processor is a business that has fixed costs with a lower level of operating expenses. Any service that the Processor can add to their portfolio of services will have a cost of implementation but once implemented can yield high profits to the Processor as add on business. The add on business potential for the Processor include innovative Financial Transaction business based upon the present invention. Programs can include Loyalty programs for the Merchant and Bank, direct marketing programs for the Merchant and Bank, non-personal Buyer demographic data for the Merchants and the Bank, and enhanced electronic-banking programs for the Bank, as examples.

### BRIEF DESCRIPTION OF THE DRAWINGS

FIG. 1 is a graphical illustration of potential communications between a buyer and merchants of different varieties along with a bank/processor in the performance of a financial transaction related to the purchase of a product or services;

FIG. 2 is a graphical illustration showing potential communications between a buyer, a merchant and bank/processor with a point of sale device and with alternative methods according to the present invention;

FIG. 3 is a graphical illustration of lines of data communication according to methods of the present invention;

FIG. 4 is a graphical illustration of lines of data communication according to alternative methods of the present invention;

FIG. 5 is a graphical illustration of lines of data communication according to other alternative methods of the present invention;

FIG. 6 is a graphical illustration of lines of data communication according to yet other alternative methods of the present invention;

FIG. 7 illustrates tracks of a magnetic stripe of a transactional card including data in accordance with the present invention;

FIG. 8 shows a personal communication device as being modified with variable data illustrated as a 2 dimensional bar code; and

FIG. 9 illustrates a processing track for financial transactions.

### DETAILED DESCRIPTION

The following detailed description of aspects of the present invention includes graphic illustrations to provide clarity to the understanding of the present invention. The provided graphic illustrations are for illustrative purposes only and not to be considered as limitations for the present invention.

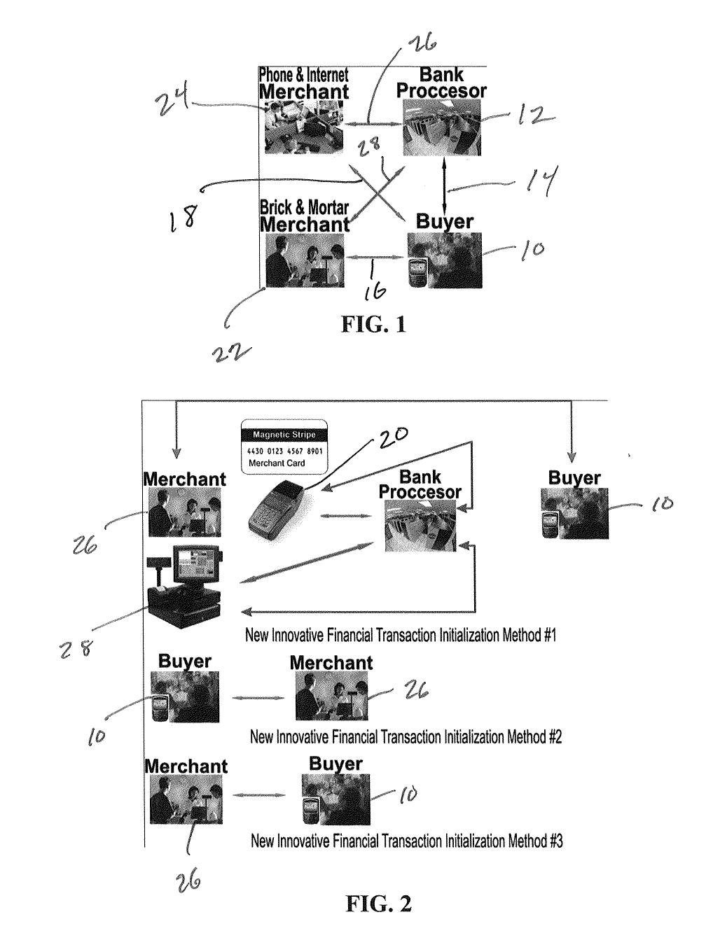

A Buyer in the past did not communicate with the Bank/Processor during a Legacy Financial Card, Financial Transaction. Only the Merchant had direct communications with the Bank/Processor. Under Financial Transaction processes of the present invention, a Buyer can now have a direct connection to the Bank/Processor. As shown in FIG. 1, a Buyer 10 can communicate directly with a Bank Processor 12, as illustrated by the two directional arrow 14. While the discussion here-to-for has noted a Mobile Phone 20 (see FIG. 2) as an exemplary means of communication between a Buyer 10 and a Bank/Processor 12, a Buyer's personal computer, Wi-Fi connected PDA or any other electronic means of communication between the Buyer and the Bank/Processor could be utilized. The arrow paths 16 and 18 represent communications paths between a Buyer 10 and a Merchant, the Merchant being represented as either a brick and mortar store 22 or a phone or internet business 24. These paths 16 and 18 are fundamentally the same paths for a Legacy Financial Card and a Financial Transaction in accordance with Financial Transactions of the present invention that can preferably utilize the same infrastructure of POS System hardware that is in place today. The arrow paths 26 and 28 represent the potential communication paths between the Bank/Processor 12 and the Merchants 22 or 24, which communications are also fundamentally the same paths for the Legacy Financial Card transaction as they are for Financial Transactions of the present invention that preferably can also utilize the same infrastructure of POS System hardware in place today. Because POS systems are widely diverse, it is likely that some POS Systems will require minor updated software to utilize Financial Transaction methods of the present invention along with many improved features, as detailed greater below.

In accordance with the present invention, there are multiple methods that will be described below for initializing an Innovative New Financial Transaction with reference to FIG. 2. While each method described and illustrated provides an exemplary method, other methods could be utilized within the scope of this invention. The assumption of a financial transaction, in general, is that a Buyer 10 wishes to purchase goods or services from either a brick and mortar Merchant 22 or from a phone or internet Merchant 24 and that a Financial Transaction is to be conducted for payment from the Buyer 10 to the Merchant 22 or 24 for the good and/or services.

One method of the present invention is as follows. Within this exemplary method, multiple variations are also contemplated depending of the POS System that is currently being employed by a Merchant.

Small Merchant who does not use a computerized POS System—A Merchant 26 can calculate a Buyer's invoice using hand techniques or a computer that is not attached to a POS System 28. The total monetary value of the invoice (Payment) will be calculated. The Merchant 26 can swipe a Bank/Processor Merchant card in the POS terminal, then enter the total payment into the POS terminal, and hit the send key, which are the same actions as those typical for initializing a Legacy Financial Card transaction. The firmware in the POS terminal can then preferably electronically send data onto the Financial Card Payment Network and be routed to the Bank/Processor. From a magnetic stripe of a card, the Bank/Processor can receive, at a minimum, the Merchant's name, a 16 digit account number, and Payment data. A second Merchant's Bank/Processor Identification Number could be received as well as additional data contained on the magnetic stripe and general data included by the POS hardware, firmware. Using this data, the Bank/Processor's software application can recognize the Financial Transaction as an Innovative New Financial Transaction and proceed as controlled by the Bank/Processor's software program. The Bank/Processor can then return to the Merchants POS System an intermediate receipt that at a minimum contains a 2 to 5 digit number that will represent a control number for this Financial Transaction along with Payment data. The control number can be varied in any number of ways.

Large Merchants who use a computerized POS System—The Merchant can enter a Buyer's purchases into the computerized POS System. The computer will calculate the total monetary value of the invoice (Payment). The Merchant can verify the data and hit the send key which is the same action as initializing a Legacy Financial Card transaction. The software in the computer will preferably electronically send the data onto the Financial Card Payment Network and be routed to the Bank/Processor. From the data generated by the computerized POS System, a Bank/Processor can preferably receive, at a minimum, the Merchant's name and/or a 16 digit account number, and Payment data. A second Merchant's Bank/Processor Identification Number could also be received as well as additional general data that is included by the computer. Using this data, the Bank/Processor's software application can recognize the Financial Transaction as an Innovative New Financial Transaction and proceed as controlled by the Bank/Processor's software program. The Bank/Processor can return to the Merchants POS System an intermediate receipt that at a minimum contains a 2 to 5 digit number that will also preferably represent a control number for this Financial Transaction along with Payment data. The control number can be varied in any number of ways.

Another exemplary method of the present invention is as follows. According to this method a Buyer can communicate to the Merchant a Buyer's Bank/Processor Membership Number. Methods of performing this communication could be via a Financial Card like design that contains a 16 digit Buyer's Bank/Processor Membership Number. This data could be printed in text on the card, be encoded on the magnetic stripe or both. Additional graphics or text and magnetic stripe data could all be included on the card. The Buyer could send the same data to the Merchant via a Blue Tooth, WiFi or cellular communication means as well as other such means such as writing the number on a piece of paper. Next a Merchant would send data to a Bank/Processor. Legacy Merchant Financial Account Number would be sent by the Merchant to the Bank/Processor using the POS Hardware or the POS Computerized System. This data could include minimally the Merchant's Legacy Financial Account number (normally sent when processing a Financial Card transaction) generated by the POS hardware or the POS Computer System, the Buyer's 16 digit Buyer's Bank/Processor Membership Number, and the Payment data. Alternatively, using a Bank/Processor Merchant Membership Number, a Merchant could instead send both a 16 digit Bank/Processor Merchant Membership Number and a Bank/Processor Buyer Membership Number along with Payment data to the Bank/Processor. In this regard, it is contemplated that it may be required to modify software of the POS Hardware, or firmware or the POS System computer software. The magnetic stripe on a Financial Card has room for discretionary data and both the POS Hardware, firmware and the POS System computer software could be modified to incorporate, either a 16 digit Bank/Processor Merchant Membership Number or the Bank/Processor Buyer Membership Number in the data stream from the magnetic stripe in the place of discretionary data. Although a 16 digit number is contemplated to be compatible with conventional current usages, other size numbers including other type characters are also contemplated in accordance with the present invention.

Yet another New Innovative Financial Transaction Initialization is also illustrated. A Merchant can communicate to the Buyer a 2 digit (for example, other size numbers are contemplated) Financial Transaction number along with either a 16 Digit or a shorter Bank/Processor Membership Number could be sent or a Merchant's Legacy Financial Account number (normally sent when processing a Financial Card transaction). The payment data would also be included as well as other pertinent data if required. The methods of this communication could be via a Blue Tooth, WiFi or cellular communication means as well as other such means such as a printed intermediate receipt. Under this method, a Buyer could send to the Bank/Processor, using the Bank/Processor application running on the Buyer's Phone, data including minimally a Merchant's Bank/Processor Membership Number or Legacy Financial Account number (normally sent when processing a Financial Card transaction), a Buyer's 16 digit Buyer's Bank/Processor Membership Number, the 2 digit Financial Transaction code and the Payment data.

For processing a financial transaction in accordance with methods of the present invention a first assumption is, that in all cases, a Bank/Processor will have received a notification that a Bank/Processor membership Financial Transaction is in progress. In accordance with the first method discussed above, a Bank/Processor has sent the Merchant a transaction identification 2 to 5 digit number and payment data, representing a current Financial Transaction with a Bank/Processor Buyer member. In accordance with the second method described above, a Bank/Processor has received from the Merchant a Merchant Financial Account Number (Legacy or Bank/Processor Membership number), the Buyer's Bank/Processor Membership number and the payment data. In accordance with the third described method described above, a Buyer has sent the Bank/Processor the Merchant's Financial Account Number (Legacy or Bank/Processor Membership number), the Buyer's Bank/Processor Membership number, the 2 digit Financial Transaction code and the Payment data. It is noted that in the first method, the Bank/Processor does not have the identification of the Buyer but has assigned a transaction identification 2 to 5 digit number. For the other methods, the Bank/Processor has all the required information to complete the Financial Transaction, excepting the Buyer's authorization and perhaps a gratuity if applicable.

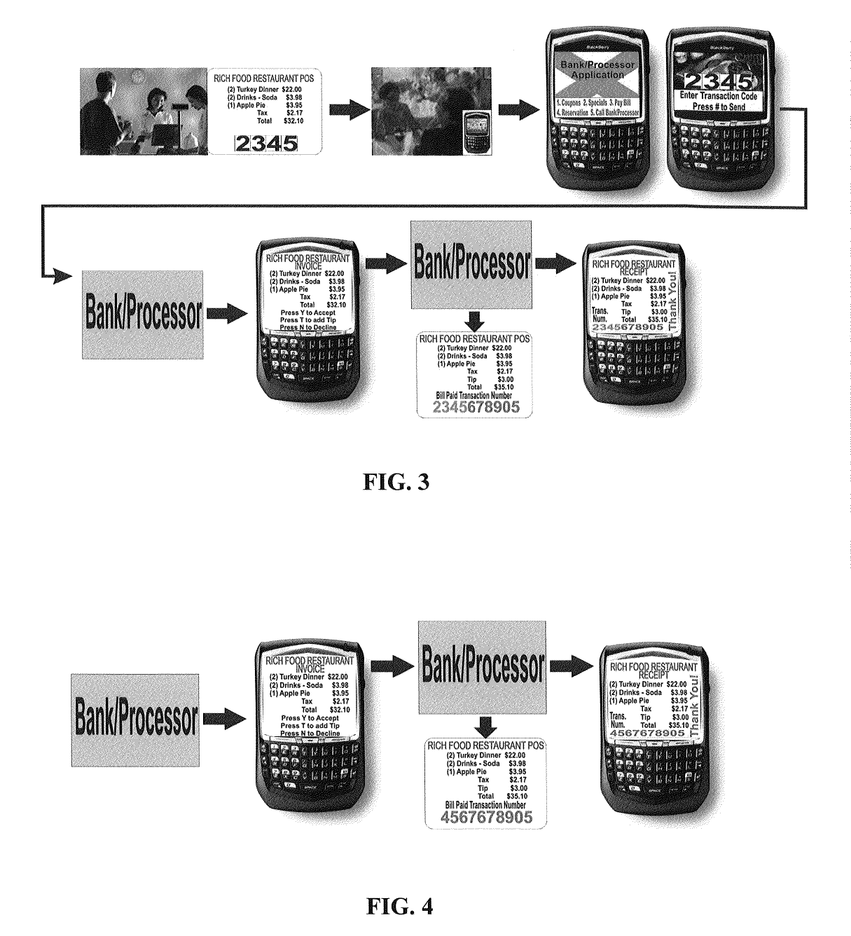

Financial Transaction Processing in accordance with preferred methods of the present invention are described as follows and initially with reference to FIG. 3.

According to a first exemplary method, Financial Transaction Processing does not expose any personal or Financial Account data about the Buyer to the Merchant, only to the Bank/Processor.

In this case, a Merchant has received from the Bank/Processor an intermediate receipt that has the payment and a 2 to 5 digit transaction number. For smaller Merchants this data will be routed through their POS Hardware and printed on the receipt printer. Larger Merchants will receive the data in their POS Computer System and can print the payment and a 2 to 5 digit transaction number or add the detailed transaction data and print an invoice as shown above. This printed invoice, or an electronically transmitted invoice, or any other chosen means can be used to provide the invoice to a Buyer.

A Buyer can start the Bank/Processor application on their Mobile Phone and, as shown in FIG. 3, press “3”, for example, to open Bill Pay. The application will next prompt for the 2 to 5 digit transaction number which the Buyer will enter using the appropriate keys on the Mobile Phone and press “#”, for example, to send via the cellular network or a Wi-Fi connection if so enabled. The data sent can include the 2 to 5 digit transaction number, the Buyer's Bank/Processor Membership number and any other appropriate data such as found in an Account Data String, and authentication data that the signal is coming from the Buyer's Mobile Phone, PIN authentication and the like.

The Bank/Processor will preferably then receive the entered data, the Buyer's Bank/Processor Membership number and any other appropriate data, such as found in an Account Data String, and authentication data that the signal is coming from the Buyer's Mobile Phone, PIN authentication and the like. The Bank/Processor can then match the 2 to 5 digit transaction number provided to the Merchant and format a message that has the Merchants name, the payment data supplied by the Merchant and send said data to the Bank/Processor application running on the Buyer's Mobile Phone.

The Buyer will preferably then receive the Merchant's invoice, add a Tip in a Popup Window if desired and press “Y”, for example, to accept the transaction or “N”, for example, to decline the transaction. By pressing “Y” the Buyer can also be assigning an electronic signature to the Financial Transaction. The Bank/Processor application will send the Tip data, if any and the Y or N to the Bank/Processor via the cellular network or a Wi-Fi connection if so enabled.

If the Transaction is accepted the Bank/Processor can use standard Legacy Financial Card processing methods to authorize the Financial Transaction and facilitate the debiting and crediting of accounts for various parties participating in the Financial Transaction. Assuming that the transaction is authorized, the Bank/Processor can also send a receipt for the Financial Transaction to the Merchant's POS Hardware or the POS Computer System and to the Buyer's Mobile Phone as shown above.

In the case that a Financial Transaction is rejected by the Buyer, not authorized by the Bank/Processor or the 2 to 5 digit transaction number is not send to the Bank/Processor by the Buyer within a time limit, the Bank/Processor can return a message to the Merchant with information describing the reason for the transaction rejection using Financial Card Legacy rejection methods. If the Buyer rejected or was not authorized, The Bank/Processor can send a message to the Buyer's Mobile Phone with information describing the reason for the transaction rejection.

To conduct methods of the invention as described above, it would be preferable to consider the following. Preferably, the Buyer's Mobile Phone transmissions can be prioritized so that the communications between the Buyer and the Bank/Processor are conducted in no more than a few seconds. A Bank/Processor can recycle the 2 to 5 digit transaction number when the transaction closes or when the time limit runs out. The used 2 to 5 digit transaction number can be placed in the bottom of the queue and recycled when at the top. Like any Financial Transaction between a Buyer and a Merchant, a Merchant will need to exercise care in assuring that the transaction is complete before the Buyer leaves the premises. A Buyer's Mobile Phone may run out of battery, cease to work, get lost or otherwise be unavailable. As such, a Bank/Processor may also issue a regular, Legacy, Financial Card that can be processed using Legacy methods for such occasions. These described and suggested methods of the present invention would provide a faster, simpler method for restaurants and similar service Merchants compared to Legacy Financial Card methods since often a waiter will make 3 or more trips to a table, often waiting each time, to complete a transaction. The innovative Financial Transaction process described here within only requires a single trip to the table by the waiter.

Another method for Financial Transaction Processing in accordance with the present invention is described as follows and with reference to FIG. 4. According to this exemplary method, a Financial Transaction processing step exposes a Buyer's Financial Account number to a Merchant. This can be the only data exposed and is unlikely to be problematic since the Merchant's or any other fraudulent attempt to use that number will be stopped by the Buyer rejecting the attempt or the Bank/Processor stopping the transaction based on a non-authenticated phone or PIN, as described.

In this example, a Bank/Processor will have already received a Buyer's Bank/Processor Membership number, a Merchant's Bank/Processor Membership number, or a Merchant Legacy Financial Account number, each as described above, along with the payment totals or payment details and totals and other data pertinent to the transaction. The Bank/Processor will match the Buyer's Bank/Processor Membership number, provided to the Merchant, to Buyer information in their database and format a message that has the Merchants name, the payment data supplied by the Merchant and send this data to the Bank/Processor application on the Buyer's Mobile Phone. It would be preferable that a Buyer's Mobile Phone's operating system would allow for launching an application based on incoming data. If not, a Buyer would need to have started the Bank/Processor application.

Preferably, the Buyer will receive the Merchant's invoice, add a Tip in a Popup Window, if desired, and press “Y”, for example, to accept the transaction or “N”, for example, to decline the transaction. By pressing “Y” the Buyer can also be assigning an electronic signature to the Financial Transaction. The Bank/Processor application can then send the Tip data, if any and the Y or N to the Bank/Processor via the cellular network or a Wi-Fi connection if so enabled.

If the Transaction is accepted, the Bank/Processor can use standard Legacy Financial Card processing methods to authorize the Financial Transaction and facilitate the debiting and crediting of accounts for various parties participating in the Financial Transaction. Assuming that the transaction is authorized, the Bank/Processor can send a receipt for the Financial Transaction to the Merchant's POS Hardware or the POS Computer System and to the Buyer's Mobile Phone as shown above. In the case that the Financial Transaction is rejected by the Buyer or not authorized by the Bank/Processor, the Bank/Processor can return a message to the Merchant with information describing the reason for the transaction rejection using Financial Card Legacy rejection methods. The Bank/Processor can also send a message to the Buyer's Mobile Phone with information describing the reason for the transaction rejection.

Methods in accordance with the above-described aspects of the present invention would provide a faster, simpler method for all types of Merchants compared to Legacy Financial Card methods. The innovative Financial Transaction process described here within only requires a single trip to the table by the waiter and a single card swipe and press the “Y” key on a Mobile Phone for Brick and Mortar retailers. While the issue remains of sending two Financial Account numbers Buyer and Merchant, the many ways of solving the problem should easily overcome any reluctance for a minor change to PUS Hardware firmware or POS computer system software.

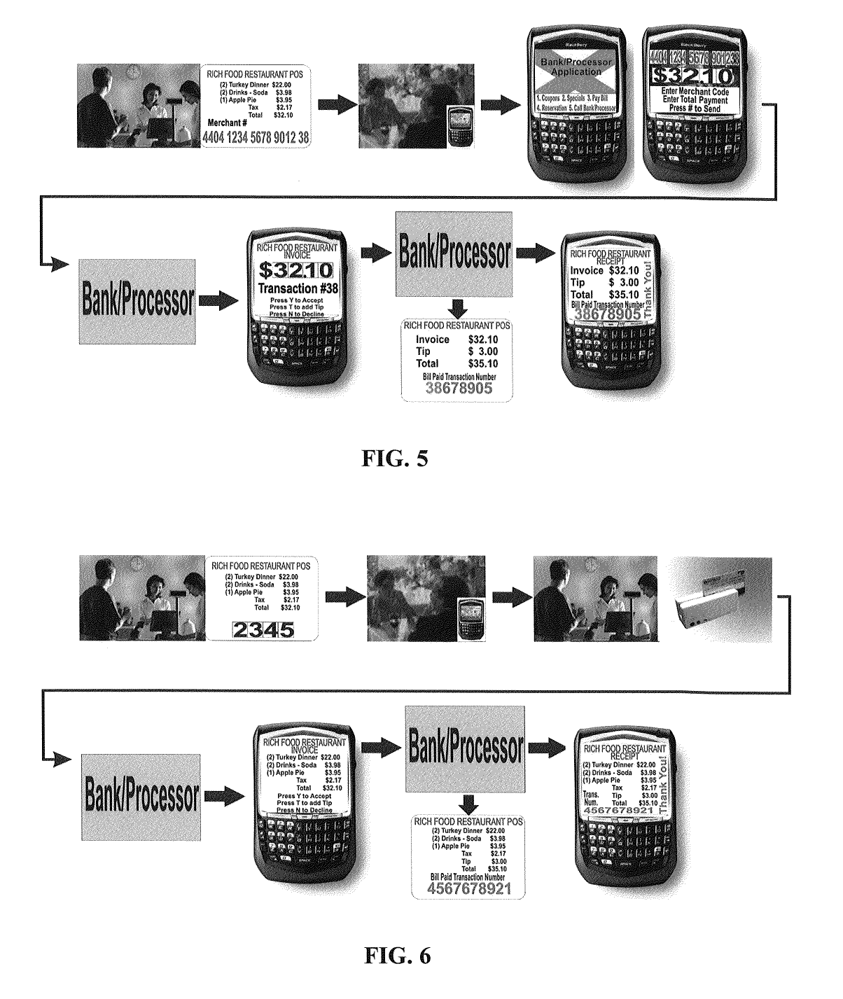

Yet another example of methods in accordance with aspects of the present invention are described below with reference to FIG. 5. In the case where a Merchant has already sent to the Buyer an invoice, the invoice could include the Merchant's Bank/Processor Membership number or a Merchant Legacy Financial Account number and payment data as a total payment or a detailed list of goods and services purchased plus tax as shown above. A Buyer can start the Bank/Processor application on their Mobile Phone and, as shown in FIG. 4, press “3”, for example, to open Bill Pay. The application will preferably next prompt for the Merchant's Bank/Processor Membership number or a Merchant Legacy Financial Account number including a 2 digit transaction code and the payment data, which the Buyer will enter using the appropriate keys on the Mobile Phone and press “#”, for example, to send via the cellular network or a Wi-Fi connection if so enabled. The data sent can include the entered data noted above, the Buyer's Bank/Processor Membership number plus any other appropriate data, such as found in an Account Data String, and authentication data that the signal is coming from the Buyer's Mobile Phone, PIN authentication and the like.

A Bank/Processor can then receive the entered payment data, the Merchant's Bank/Processor Membership number or a Merchant's Legacy Financial Account number, the 2 digit transaction number and any other appropriate data, such as found in an Account Data String, and authentication data that the signal is coming from the Buyer's Mobile Phone, PIN authentication and the like. The Bank/Processor will preferably match the Buyer's Bank/Processor Membership number and the Merchant/Processor Membership number or Legacy Financial Account number, to information in their database and format a message that has the Merchants name, the payment data supplied, the 2 digit transaction number and then can send this data to the Bank/Processor application on the Buyer's Mobile Phone.

A Buyer can then receive the Merchant's invoice, add a Tip in a Popup Window if desired and press “Y”, for example, to accept the transaction or “N”, for example, to decline the transaction. By pressing “Y” the Buyer can also be assigning an electronic signature to the Financial Transaction. The Bank/Processor application can then send the Tip data, if any and the Y or N to the Bank/Processor via the cellular network or a Wi-Fi connection if so enabled.

If the Transaction is accepted, a Bank/Processor can use standard Legacy Financial Card processing methods to authorize the Financial Transaction and facilitate the debiting and crediting of accounts for various parties participating in the Financial Transaction. Assuming that the transaction is authorized, the Bank/Processor can send a receipt for the Financial Transaction to the Merchant's POS Hardware or the POS Computer System and to the Buyer's Mobile Phone as shown above. In the case where the Financial Transaction is rejected by the Buyer or not authorized by the Bank/Processor, the Bank/Processor can return a message to the Merchant along with information describing the reason for the transaction rejection using Financial Card Legacy rejection methods. The Bank/Processor may also send a message to the Buyer's Mobile Phone with information describing the reason for the transaction rejection.

Methods of the present invention as described above would provide a safe method for the Buyer to complete the transaction but at the cost of entering more data at least one time. A 16 digit Merchant's Bank/Processor Membership number or a Merchant's Legacy Financial Account number and 2 digit transaction would require hand entering 18 digits. The Bank/Processor application on the Buyer's Mobile Phone would preferably save the Merchant's Name, the Merchant's Bank/Processor Membership number or a Merchant's Legacy Financial Account number in a file with other Merchant data so that this information would only need to be entered once. The Buyer could enter payment data and the 2 digit transaction number every time. The Merchant would wait until they received a payment receipt before matching the 2 digit transaction number to an open invoice for the same payment or payment plus Tip. The Financial Transaction process described herein would only requires a single trip to the table by the Merchant's waiter, for example.

While the methods described and suggested above are all improved and effective methods of processing a Financial Transaction and have benefit for both the Merchant and the Buyer, yet another alternative method is contemplated that is a compromise between the Legacy Financial Card method and the New Innovative Financial Transaction Methods discussed above. Bank/Processors, ISOs and other Financial Card Market participants are part of an industry the issues Financial Cards. The Financial Transaction for those cards normally involves a Bank or Processor to conduct and settle the monetary portion of the transaction. The Bank/Processor typically has a software application that runs on secured computer servers and data networks that normally connect to Merchant POS systems including brick and mortar, phone and internet sales. For the vast majority of Financial Transactions, this process is automated and does not require human intervention. It is the Bank/Processor that writes or has written the Software that provides this service. Of course the software and system involved must be approved by relevant agencies to participate in this industry.

The methods described above require some changes to the Bank/Processor software application in order to provide the features and benefits noted in the discussion including the additional services surrounding new Merchant marketing potential. There are also potential minor changes to POS Hardware firmware and POS Computer System software required for some of the noted methods. The following alternative Financial Transaction process will not require any changes on the part of the Merchant or the Merchant's POS Hardware firmware or the POS Computer System software. An alternative method is described below with reference to FIG. 6.

According to this alternative method, a Legacy Financial Card can be used in a method for initiating a Financial Transaction. A standard plastic credit, debit, prepaid or gift card's magnetic stripe can be used for this method. A card Financial Account number will have been issued by a Bank/Processor running a software program that has implemented the features of the following method. A 16 digit Legacy Financial Account PAN number can be in a class of cards where all the cards in the class will use this method and such number can include features or a single card's 16 digit Legacy Financial Account PAN number can be tagged in the Bank/Processor database to use this method's features. This method may expose a Buyer's personal (Name) and account information to a Merchant or other potential identity thieves if a credit, debit or named prepaid card is used. The risk, however, is low since any Financial Transaction using a card protected by this method of transaction will not be completed without a communication from a card holder's Mobile Phone agreeing to the transaction.

A Merchant would prepare an invoice for the Buyer denoting the goods and services purchased with the tax included and provide this invoice or minimally provide the total required payment to the Buyer. A Buyer, using a Bank/Processor issued Financial Card, could provide the card to the Merchant for swiping in their POS hardware or swiping the card themselves. The Merchant POS Hardware or POS Computer System would initialize a traditional Financial Card transaction. The firmware in the POS terminal or the software in the POS Computer System would then preferably electronically send the data onto the Financial Card Payment Network and be routed to the Bank/Processor. From the magnetic stripe, the Bank/Processor will receive, at a minimum, the Merchant's name and account data, the Buyer's 16 digit card Financial Account number, the expiration data, the CVV code and the Payment data. Additional data contained on the magnetic stripe and general data included by the POS hardware, firmware could also be sent. Using this data, the Bank/Processor's software application can recognize the Financial Transaction as an Innovative New Financial Transaction and proceed as controlled by the Bank/Processor's software program. The Bank/Processor can then match the Buyer's Bank/Processor 16 digit Financial Account card number to information in their database and then format a message that has the Merchants name, the payment data supplied by the Merchant and preferably send this data to the Bank/Processor application on the Buyer's Mobile Phone.

A Buyer can receive the Merchant's invoice, add a Tip in a Popup Window if desired and press “Y”, for example, to accept the transaction or “N”, for example, to decline the transaction. By pressing “Y” the Buyer can also be assigning an electronic signature to the Financial Transaction. The Bank/Processor application will preferably send the Tip data, if any and the Y or N to the Bank/Processor via the cellular network or a Wi-Fi connection if so enabled. If the Transaction is accepted, the Bank/Processor can use standard Legacy Financial Card processing methods to authorize the Financial Transaction and facilitate the debiting and crediting of accounts for various parties participating in the Financial Transaction. Assuming that the transaction is authorized, the Bank/Processor can send a receipt for the Financial Transaction to the Merchant's POS Hardware or the POS Computer System and to the Buyer's Mobile Phone as shown in FIG. 6. In the case where the Financial Transaction is rejected by the Buyer or not authorized by the Bank/Processor, the Bank/Processor can return a message to the Merchant with information describing the reason for the transaction rejection using Financial Card Legacy rejection methods. The Bank/Processor can also send a message to the Buyer's Mobile Phone with information describing the reason for the transaction rejection.

This method is advantageous by providing a safe method for the Buyer to complete the transaction but the transaction can be accepted by any Merchant that process Financial Cards. The Merchant not only does not need a membership with the Bank/Processor or be required to update POS Hardware, firmware or POS Computer System software; they don't even need to know that the Financial Transaction processing is non-standard. The innovative Financial Transaction process described here within only requires a single trip or other effective communication to the Buyer by the Merchant's service provider.

According to another aspect of the present invention, the power and attraction of open-loop cards or Mobile Phones can be more effectively utilized. This aspect of the present invention utilizes open loop networks and preferably utilizes a Mobile Phone in place of a card. A problem with using a Mobile Phone in the current card swiper environment is that a Mobile Phone does not have a magnetic stripe that can be read to initiate the transaction. The data located in the magnetic stripe of a card and added by the Merchant should identify the Buyer, the Merchant, an open loop network, a Processor of said transaction, a Bank of the Merchant and a Bank account of the Buyer from which the funds will be used to pay for the transaction. The magnetic stripe on the card is “swiped” or read by a point of sale device and the information and Merchant data is passed through the open loop network to the Banks for payment. The company that is responsible for the transmission of this data is called a “Processor.” This aspect of the present invention addresses a Buyer point of sale transaction or “front end” and the Merchant processing transaction or “back end” of such a transaction.

As describe above in the Background section, Financial Cards are expensive to produce, easy to defraud and contribute to identity theft. Since most people have many different Financial Accounts they need to carry multiple cards, which is burdensome and increases the risk of losing a purse or billfold. One solution is to include Financial Account information within and to be displayed on a screen of a Mobile Phone and to use secure electronic data transfer steps to transfer the account and personal information. It is preferable in accordance with the present invention to provide variable data that can be uploaded with the Financial Transaction that would trigger modifications to the Financial Transaction. Also, it would be beneficial for a Merchant that uses a POS Computer System to be able to modify the magnetic stripe data before uploading the Financial Transaction and/or for a Mobile Phone to modify the data before uploading the Financial Transaction. Manners of achieving these desired results are described below.

According to this aspect of the present invention, desired solutions to present problems are addressed by adding features to standard Financial Transaction system methods, hardware, software and transactional capability. This process will reduce the cost and increase the speed of implementation, add Financial Transaction beneficial features that would otherwise not be available and be more transparent in the entire process.

It should also be noted that the end result of this process is a modified Financial Transaction in some of the process steps. A Buyer can buy an article or service and receive some sort of consideration for that purchase. The consideration may be a reduction in cost, a reduction in cost on a later purchase, loyalty rewards, payment options or other means of modifying the Financial Transaction that is beneficial to the Buyer. In the past the Merchant would need a means of implementing the Financial Transaction modification. For example, a Buyer would present a coupon, ticket or gift card, the POS clerk would scan or hand enter data on the coupon, ticket or gift card into the POS system, the Buyer could be asked to sign or provide other means of identity, the clerk hopefully would do all that is required to fulfill the modified transaction. The Buyer, if alert, would check the receipt to be sure the transaction was correct. This all takes time for both the clerk and Buyer and has a real chance of failure.

The aspect of the process of the present invention is within a conducting of a Financial Transaction including modified Financial Transactions, not at the point of sale, but at the financial Processor. The financial Processor could discount purchases, redeem gift cards or tickets, debit or credit loyalty points, record future discounts and the like, all of which will take place in the processing of a Mobile Phone Financial Transaction (hereafter Phone Transaction) and change the processing method and actions taken based data received from the Merchant and Buyer.

In order to implement the core inventive Financial Transaction process, a first step is to assure that the process is implemented at the point of sale. An assumption is that the Financial Transaction is routed to a Processor that has a modified Financial Transactions processing software enabled. A 16 digit PAN Financial Account number controls the routing of the Financial Transaction to the Processor and other parties. There are multiple methods of accomplishing the routing of the required data including those noted as follows.

For Financial Transactions that take place using a Legacy Financial Card with a Legacy PAN Financial Account and account data, a POS Computer System could be used to modify the Account Data String being sent to the Processor as a Modified Account Data String. Since the Legacy account data would be only that required for a Legacy Financial Transaction, the POS Computer System could make the changes to the Account Data String being uploaded to the Processor. Note that even if the transaction is a phone transaction, the account data can be modified to process additional features before being uploaded to the financial Processor.

For smaller Merchants where there is no connected POS Computer System and the Financial Transaction is entered via a POS device such as a VeriFone VX series POS device, as is currently commercially available from Verifone Systems Inc. of San Jose, Calif., the VX series can be enabled to read a Mobile Phone displayed 2D code that contains the Modified Account Data String or any other means that allows the electronic transfer of data to the POS Hardware. For example, the reader device for electronically readable data is connected to the RS232 port on the Verifone VX series reader and enters the account data into the VX device no differently than having swiped a Financial Card. No additional software (firmware) or hardware modifications at the point of sale are required to implement this method.

A method that could also be conducted and effective is the sending the Merchant number, Financial Account and the transaction modification variable data directly from the Mobile Phone to the Processor. This option is discussed in more detail below.

The next step is the modification of an Account Data String. While there are many schemes that would work inside of processes of the present invention, an exemplary method would be to use a scheme that verified the Merchant, identified the program/s that are to be applied to the transaction and added variable program data such as percentage off, monetary value of the discount, points to be awarded of debited, expiration dates and the like. An Account Data String for a magnetic stripe is illustrated in FIG. 7 as including a track 1 and a track 2. For example track 1 of the Account Data String could include in addition to the Legacy financial account data: the following: (3) 6 bit characters that identify the Merchant; and (6) 6 bit characters that identify the program/s for a particular Merchant. Track 2 could include: (9) 4 bit characters that would contain the variable data for the particular Merchant programs. Track 3 could include: up to (104) 4 bit characters. The character strings would be positioned in order to identify correct values for each program control.

According to the illustrated magnetic stripe tracks 1 & 2 sample data string, the “Z”s denote variable transaction modification data. Account data can be modified either in the POS computer or on the Buyer's Mobile Phone within the scope of this invention.

A third step is as follows. A first procedure for Mobile Phone transactions would be a step of downloading transaction modification programs to the Mobile Phone. Phone applications on the Mobile Phone, specific to the Merchant, a group of Merchants or all holders of a given type of Financial Account, for example, would process the transaction modification programs. The phone application/s would preferably manage any marketing collateral such as coupons, discounts, loyalty promotions and the like from the Merchant's or account provider. The phone application software could be downloaded through various common means and loaded into the phone as an application. Certainly the phone application could have other features that are outside the scope of this application. A big advantage to the Buyer is that they no longer need to cut out and have coupons on hand, VIP cards, specials for the newspaper or TV or any other cost savings method that requires an activity on their part. Any transaction modification program cost reduction or other benefit, on their phone or in conjunction with the card Processor and Merchant, can automatically be applied to the sale during the transaction at the Processor.

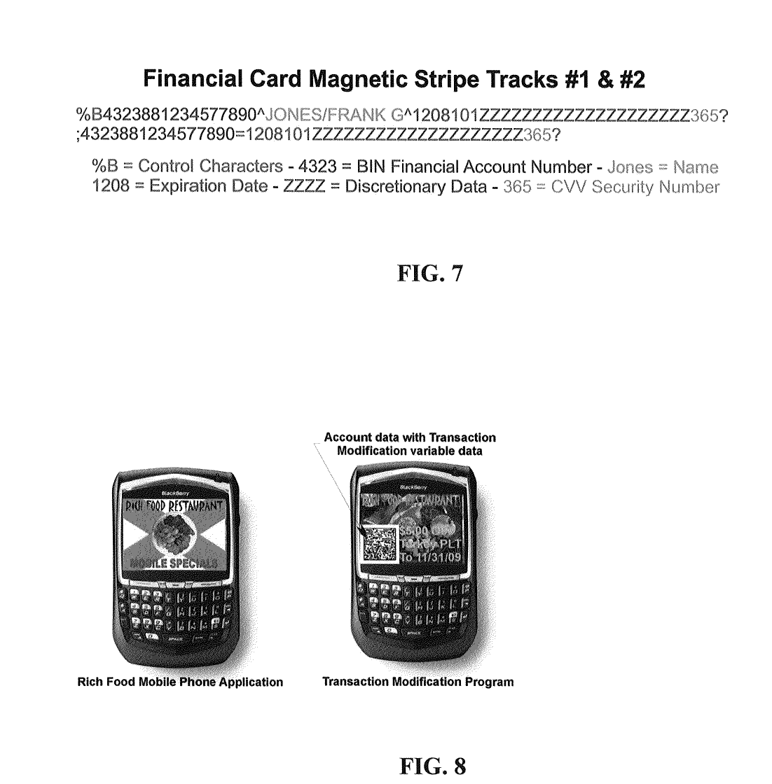

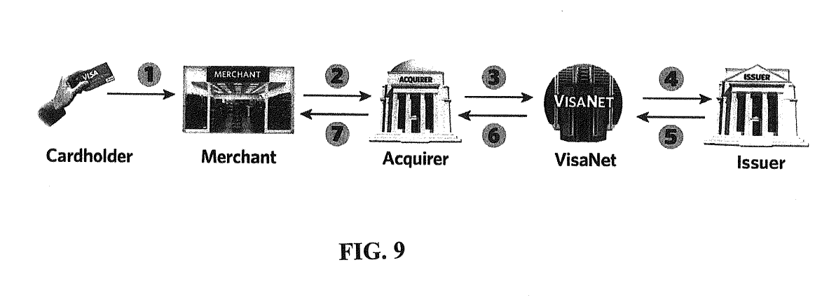

The next step is the transfer of data from a Mobile Phone to a POS Computer or the PUS device at the point of sale. The scope of the present invention includes any means of transfer where data on the phone is electronically sent to the POS Computer or the POS device at the point of sale such as the use of Bluetooth, WiFi, Audio, infrared, 2D Code reader and the like. An exemplary means is the use of a 2D code such as is illustrated in FIG. 8. Veritec phone reader, FM200, as commercially available from Veritec Inc. of Golden Vallery, Minn., for example, is an ideal, low cost choice for a 2D code reader device that can be directly connected to the POS Computer or the POS device at the point of sale without the addition of software or changes to hardware.

Note that another step of the present invention is to send account data with the transactional modification variable data or a 2D code containing the data directly to the Processor from the Buyer's Mobile Phone using a Merchant number assigned by the Merchant phone application. As above, a Merchant could send data to the Processor but without the Buyer's Bank/Processor Membership Number. The difference is the Modified Account Data String that will effect changes to a Financial Transaction being processed or the method of processing the transaction.

A process of the present invention can include the following steps. First, a Merchant could send, via electronic means, a Merchant number and an itemized bill or summary of the bill to a Processor. The Processor would reply to the Merchant, such as via electronic means, with a 2 to 5 digit code, for example, that would be the identification number for the transaction. Then, the Merchant could provide the Buyer an itemized receipt with the 2 to 5 digit code or any other means that would provide the Buyer the 2 to 5 digit code. After that, the Buyer would preferably enter the 2 to 5 digit code into an application running on their phone that would send the 2 to 5 digit code, such as via electronic means, the Buyer's Financial Account data, the Modified Account Data String transactional modification variable data if any such offerings are on the phone for a particular Merchant or group of Merchants and a key enabled data point for a tip if desired to the Processor. Then, the Processor could match the 4 digit number to the data received from the Merchant and, if a match is found, modify the transaction according the modification variable data from either the Merchant or Buyer, and send, via electronic means, the Buyer details of the transaction to the Buyer's Mobile Phone application allowing the Buyer to refuse or accept the transaction by sending or not sending an acceptance or refusal to the Processor via the Buyer's Mobile Phone. Based on an acceptance, send, via electronic means, the Merchant the transaction completion data and the Buyer a receipt to the Buyer's Mobile Phone or based on a refusal a refusal message to both the Merchant and the Buyer's Mobile Phone. The Merchant could also issue a paper receipt and provide said receipt to the Buyer including the requirement for a signature after receiving the transaction completion data.

Alternatively, a linear barcode or a 2D barcode, containing Merchant identification number, can be printed on a placard or electronically displayed at the point of sale or on a printed receipt supplied to the Buyer. The Buyer can initiate a transaction by reading the Merchant code, such as using the phone's camera, with a barcode reading application loaded on the phone. The Merchant's identification code and the Buyer's Modified Account Data String or Account Data String can then be sent to the Bank/Processor, via the Buyer's Mobile Phone where the Merchant and Buyer are identified by the Processor and the account of the Buyer from which the funds will be used to pay for the transaction. A unique purchasing phone code can be generated and sent to back to the Buyer's cell phone. This unique purchasing code preferably contains a preauthorization for the transaction. Items to be purchased can then be tabulated on the Merchant's cash register and the POS code reader can be prompted to receive authorization for payment. The Mobile Phone display may then be placed on the reader and the transaction is authorized or the Merchant can manually read the purchasing code from the phone display.

Yet another alternative is for the Merchant to produce a 2D code or other electronically readable data method that contains the Merchant identification, the itemized or summary bill, transactional modification variable data and any other pertinent data which is then shown on a POS device display or printed on a Buyer receipt. The Buyer can initiate a transaction by reading the Merchant code, such as using the phone's camera, with an application loaded on the phone. The application adds to the Merchant data the Buyer's Modified Account Data String data or Account Data String, the transactional modification variable data if any such offerings are on the phone for a particular Merchant or group of Merchants and a key enabled data point for a tip if desired which is all sent to the Processor via electronic means. The Processor would preferably process the data and modify the transaction according the modification data from either the Merchant or Buyer, send the Buyer details of the transaction to the Buyer's Mobile Phone allowing the Buyer to refuse or accept the transaction by sending or not sending an acceptance or refusal to the Processor via the Buyer's Mobile Phone. Based on an acceptance, send the Merchant, via electronic means, the transaction completion data and the Buyer a receipt to the Buyer's Mobile Phone or based on a refusal a refusal message to both the Merchant and the Buyer's Mobile Phone. The Merchant could also issue a paper receipt and provide said receipt to the Buyer including the requirement for a signature after receiving the transaction completion data.

Note that the same steps and actions in the alternatives could occur using a computer rather than a Mobile Phone for transactions where the Buyer is or is not present at the Merchants location and the Buyer receives the 2 to 5 digit code or other data via his computer and sends his required Financial Account data to the Processor via his computer and receives data back from the Processor via his computer. The same is true for a Buyer not present where the Buyer receives the 2 to 5 digit number or other data including a 2D Code via voice on their phone or a phone text message and completes the transaction as above using their Mobile Phone.

Also note that transaction completion data could take the same form as a traditional Financial Card transaction where data is returned to a POS device or to the Merchant's computer where software in the computer completes the transaction details or any method that supplies the Merchant the data required to complete the transaction. Also note that the alternatives can be combined is such ways that the novel aspects are maintained in the inventive method and individual steps inside the alternative methods can be eliminated while still maintaining the other steps as inventive steps

A further step is the upgrading of a processing center to house all of the software required to implement the transaction from transactional modification variable data. The transaction will be handled like a restaurant transaction where an authorization hold is placed on funds until the Buyer has a chance to verify the transaction and modify the transaction if required (the Merchant will also have a chance to verify the final transaction value). The processing center application will next direct returned data to the Merchant's POS and the Buyer's Mobile Phone for verification and approval or modifications. When the Buyer and Merchant are satisfied, then a second transaction is registered that completes the finalized transaction. The Processor can send receipt data to the Buyer's Mobile Phone and the Merchants POS computer or device. Any additional checks, such as being sure the transactional modification variable data has not expired or has already been used, the account holder has funds in the account to complete the transaction, because of the large value of the transaction additional card holder identification is required or any other requirements for the transaction completion are fulfilled.

The transactional modification variable data can determine which program will be called in the Merchant phone application and additional variable data may also be applied to determine the values of a transaction modification. A Merchant sale transaction can be completed with adjustments as dictated by the transaction modification program. For phone tickets or phone gift cards the Processor fulfillment will behave as if the transaction is a stored value card and the debiting and crediting of accounts will be handled the same as if it were a stored value card. Loyalty or other such programs would be handled as prescribed by the phone application software and variable transaction modification data debiting and crediting points or monetary values. There is nothing in the process of the present invention that will stop a normal Financial Card or phone transaction from being completed without the use or availability of transactional modification variable data at an upgraded processing center.

Within the scope of the invention are other transactions such as extended payments, future value such as any amount off the next transaction with the Merchant, medical payments such as co-pay and variable prescribed drug costs and automated deductions such as a percentage for senior citizens. The number of transactional and service possibilities is numerous.

In FIG. 9, a Legacy Financial Card Transaction is illustrated. As shown, the terms Acquirer and Issuer have the functions of the Bank/Processor in this disclosure. This Legacy Financial Transaction method has only the steps shown with no modification allowed to either the monetary or other real value of the or Financial Transaction or the method of processing the Financial Transaction. The Financial Transaction methods of the present invention would allow either the Acquirer or the Issuer to act as the Bank/Processor and make modifications to the Financial Transaction being processed or the method of processing the Financial Transaction based on the Modified Account Data Strings sent to a Bank/Processor.

Steps of using such a card include, the cardholder presenting the merchant with a credit card for payment. A merchant POS terminal reads the account number and other data encoded on the card's magnetic stripe or chip. The merchant terminal transmits the card information and transaction amount to the acquirer. Then, the acquirer combines the transaction information into an authorization request message and transmits to an open loop network provider. They then route the authorization request to the issuer for review. The issuer send an authorization response back to the open network either approving or denying the transaction. This message is routed back to the acquirer, and the acquirer transmits the result of the authorization request to the merchant terminal.

A magnetic stripe card is a type of card capable of storing data by modifying the magnetism of tiny iron-based magnetic particles on a band of magnetic material on the card. The magnetic stripe, sometimes called swipe card or magstripe, is read by physical contact and swiping past a magnetic reading head. A number of International Organization for Standardization standards, ISO/IEC 7810, ISO/IEC 7811, ISO/IEC 7812, ISO/IEC 7813, ISO 8583, and ISO/IEC 4909, define the physical properties of the card, including size, flexibility, location of the magstripe, magnetic characteristics, and data formats. The magnetic stripe contains three tracks, each 0.110 inches (2.79 mm) wide under conventional standards. Point-of-sale card readers almost always read track 1, or track 2, in the case that one track or the other is unreadable. The tracks of a magnetic stripe as including aspects that are used in accordance with the present invention are comprised as follows.

Track 1, Format B: 7-bit alphanumeric characters—210 bits per inch
Start sentinel—one character (generally ‘%’)
Format code=“B”—one character (alpha only)
Primary account number (PAN)—up to 19 characters. Usually, but not always, matches the credit card number printed on the front of the card.
Field Separator—one character (generally ‘̂’)
Name—two to 26 characters
Field Separator—one character (generally ‘̂’)
Expiration date—four characters in the form YYMM.
Service code—three characters
Discretionary data—may include Pin Verification Key Indicator (PVKI, 1 character), PIN Verification Value (PVV, 4 characters), Card Verification Value or Card Verification Code (CVV or CVK, 3 characters)
End sentinel—one character (generally ‘?’)
Longitudinal redundancy check (LRC)
   Track 2: 5-bit scheme (4 data bits+1 parity), 0-9, plus the six characters : ; <=>?
Start sentinel—one character (generally ‘;’)
Primary account number (PAN)—up to 19 characters. Usually, but not always, matches the credit card number printed on the front of the card.
Separator—one char (generally ‘=’)
Expiration date—four characters in the form YYMM.
Service code—three digits. The first digit specifies the interchange rules, the second specifies authorization processing and the third specifies the range of services
Discretionary data—as in track one
End sentinel—one character (generally ‘?’)
Longitudinal redundancy check (LRC)—it is one character and a validity character calculated from other data on the track. Most reader devices do not return this value when the card is swiped to the presentation layer, and use it only to verify the input internally to the reader.
   Track 3: Track 3 can be encoded with at 210 bits per inch equaling 107 digits of the numbers 0-9, plus the six characters : ; < >?.

While the detailed drawings, specific examples, and particular formulations given here within described exemplary embodiments, they serve the purpose of illustration only. It should be understood that various alternatives to the embodiments of the invention described maybe employed in practicing the invention. It is intended that the following claims define the scope of the invention and that structures within the scope of these claims and their equivalents be covered thereby. The materials, constructions, methods and configurations shown and described may differ depending on the chosen performance characteristics and physical characteristics of the transactional modification variable data program and its use. For example, the types of materials, constructions, security features, electronically readable data methods used may differ. The descriptions here within are not limited to the precise details and conditions disclosed. Method steps provided may not be limited to the order in which they are listed but may be ordered any way as to carry out the inventive process without departing from the scope of the invention. Furthermore, other substitutions, modifications, changes and omissions may be made in the design, operating conditions and arrangements of the exemplary embodiments without departing from the scope of the invention as expressed in the appended claims.

1. A method for conducting a financial transaction comprising:
a. sending data including modified account data strings to a bank/processor,
b. modifying the financial transaction according to bank/processor software algorithmic processes identified by said data or portions of said data, and
c. using the modifications to cause changes to the financial transaction being processed or to the method of processing the financial transaction,
d. completing the financial transaction.

2. The method of claim 1, wherein the data is within a primary account number (PAN) or within discretionary data or both in the modified account data string.
